(19) United States
(12) Patent Application Publication
(10) Pub. No.: US 2010/0220616 A1
(43) Pub. Date: Sep. 2, 2010

(54) OPTIMIZING NETWORK CONNECTIONS

(75) Inventors: Alexander Glyakov, Petach Tikva (IL); Alexei Alexevitch, Hertzlia (IL); Amatzia Ben-Artzi, Palo Alto, CA (US); Guy Ben-Artzi, Palo Alto, CA (US); Tal Lavian, Sunnyvale, CA (US); Yotam Shacham, Palo Alto, CA (US); Yehuda Levi, Rishon Lezion (IL)

Correspondence Address: CONNOLLY BOVE LODGE & HUTZ LLP, 1875 EYE STREET, N.W., SUITE 1100, WASHINGTON, DC, 20006, US

(73) Assignee: Real Dice Inc., Carson City, CA (US)

(21) Appl. No.: 12/631,125

(22) Filed: Dec. 4, 2009

Related U.S. Application Data
(60) Provisional application No. 61/208,949, filed on Mar. 2, 2009.

(51) Int. Cl. H04L 12/26

(52) U.S. Cl. 370/252

(57) ABSTRACT

Embodiments of the invention provide methods and systems for optimizing network connections by a computing device. One or more network connections between a source and a destination may be monitored for one or more values of one or more connection parameters. Thereafter, one or more values of the connection parameters of the monitored network connections may be analyzed to select one or more combinations of the values. Further, the selected combinations of the values of the connection parameters may be stored. Subsequently, one or more monitored network connections may be established based on the stored values of the combinations.

### CROSS-REFERENCE TO RELATED APPLICATION

This application draws priority from U.S. Provisional Patent Application No. 61/208,949, filed on Mar. 2, 2009, and hereby incorporated by reference herein in its entirety.

### FIELD OF THE INVENTION

The invention relates to network connections and more specifically the invention relates to optimization of network connections.

### BACKGROUND OF THE INVENTION

Various users across the globe communicate or perform various activities on computer and device networks. Moreover, the users interact with each other through the networks, such as the Internet. Typically, the users use devices like personal computers to interact over the Internet. The users can interact from various Internet websites or social networking sites, for example, Facebook, Myspace, Hi5, and Orkut etc. Recently, the development in mobile devices such as cell phones, smartphones and PDAs, computers, laptops and the like has enabled them to be used for performing various activities on networks such as the Internet. Moreover, the mobile devices can be used for real-time interaction with other users on the network. The interaction or communication can be in the form of chatting, playing interactive online games, browsing, shopping, music, video, banking, business and the like.

The rapid pace of innovation in technology has generated various types of devices and platforms. Moreover, the number of devices is increasing rapidly. For example, there are various operating systems available for the devices such as Windows, Linux, Macintosh, and Symbian, etc. Moreover, a large number of J2ME platforms are available for the mobile devices such as cell phones. Furthermore, the mobile devices have a wide range of capabilities in terms of screen size, screen type, screen resolution, processor, and memory etc. The advancement in technology has enabled multi-user interaction on the network, for example multi-player games on mobile devices. Moreover, with rapid decline in prices of hardware, advanced and inexpensive devices are readily available. Furthermore, advancements in software, operating systems, and input output interfaces have enabled the development of high performance media capabilities on devices. Interactive applications such as media games are now being developed which allow multi-user interactions on networks. As a result, the number of users and the requirement for the quality of service in the network is increasing rapidly.

The experience of users over the network is guided by various connection parameters such as bandwidth, latency, quality of service etc. In case of online applications such as gaming, file sharing, peer-to-peer connections etc., users often encounter low connection speed or bandwidth. In some cases the low connection speed or bandwidth is due to some adjustments at Internet Service Provider (ISP) end. For example, an ISP may implement some kind of transparent proxy that analyzes traffic, caches some network packets, and slows down low-priority connections such as file sharing, p2p, etc. As a result, slow data connection may cause login delays, disconnections, other application flow problems. For example, in case of an online game, the game might be disconnected.

Various mechanisms are available that provide solutions to slow network connections. As shown in FIG. 1A, fast port detection is a mechanism used to detect and use a low latency connection for a client 102. In case of fast port detection mechanism, a piece of software scans for open ports on a network host. Therefore, in case of latency, the connection is switched to an alternate fast port. Subsequently, an application server 104 that is providing the services over a network 106 can then be connected with a main application executing on client 102 through the low latency connection.

In some cases, a particular protocol may not be supported by a network connection. Moreover, an ISP or service provider can block a particular connection over a network connection. For example, Transmission Control Protocol (TCP) may be allowed over mobile phone communication, while Hyper Text Transfer Protocol (HTTP) may not be supported. Further, low priority connections such as file sharing or peer-to-peer connections may be slowed down by the ISP.

Generally, a mechanism known as tunneling protocol may be used to establish connection and send data over such blocked or unsupported network connection. As shown in FIG. 1B, a proprietary protocol is encapsulated with some widely used protocol headers 108 in client 102. For example, HTTP protocol may be encapsulated by TCP and communicated over a mobile phone network. Therefore, as shown in FIG. 1B, HTTP header and data packet are encapsulated by proprietary protocol 108. Moreover, HTTP protocol may encapsulate native protocols in order to path through standard Internet gateways.

In some cases, the ISP's blocks big files or long lasting files. Multi-home Server may be used in this case to change from one IP to another IP. Another technique may be to move to a new distributed server. However, moving to a new server may be complicated. For example, in case of online games, implementation of a new state machine at the new server may make the movement complicated.

Presently, the mechanisms available are not reliable or fast for online applications. A mechanism is therefore desirable for optimizing network connections.

### SUMMARY

Embodiments of the invention may provide a method for optimizing network connections by a computing device. One or more network connections between a source and a destination are monitored for one or more values of one or more connection parameters. Thereafter, one or more values of the connection parameters of the monitored network connections are analyzed to select one or more combinations of the values. Further, the selected combinations of the values of the connection parameters are stored. Subsequently, one or more monitored network connections are established based on the stored values of the combinations.

Embodiments of the invention may further provide a system for optimizing network connections. The system may comprise means for monitoring one or more network connections between a source and a destination for one or more values of one or more connection parameters; means for analyzing the one or more values of the connection parameters of the monitored network connections to select one or more combinations of the values; means for storing the selected combinations of the values of the connection parameters; and means for establishing one or more monitored network connections based on the stored values of the combinations.

Embodiments of the invention may further provide an apparatus for optimizing network connections. The apparatus may comprise: a monitoring module configured to monitor one or more network connections between a source and a destination for one or more values of one or more connection parameters; a selection module configured to analyze the one or more values of the connection parameters of the monitored network connections to select one or more combinations of the values; a memory configured to store the selected combinations of the values of the connection parameters; and a connection module configured to establish one or more monitored network connections based on the stored values of the combinations.

Embodiments of the invention may further provide a system for optimizing network connections. The system may comprise: a monitoring module configured to monitor one or more network connections between a source and a destination for one or more values of one or more connection parameters; a selection module configured to analyzing the one or more values of the connection parameters of the monitored network connections to select one or more combinations of the values; a memory configured to store the selected combinations of the values of the connection parameters; and a connection module configured to establish one or more monitored network connections based on the stored values of the combinations.

Embodiments of the invention may further provide a computer-readable medium having instructions to be executed by a processor for optimizing network connections. The computer-readable medium may have stored thereon instructions that, if executed by a computing device, may cause the computing device to execute a method comprising: monitoring one or more network connections between a source and a destination for one or more values of one or more connection parameters; analyzing the one or more values of the connection parameters of the monitored network connections to select one or more combinations of the values; storing the selected combinations of the values of the connection parameters; and establishing one or more monitored network connections based on the stored values of the combinations.

### BRIEF DESCRIPTION OF THE DRAWINGS

Having thus described the invention in general terms, reference will now be made to the accompanying drawings, which are not necessarily drawn to scale, and wherein:

FIGS. 1A and 1B illustrate functional overview of prior art techniques to optimize network connections;

FIG. 2 illustrates an environment where various embodiments of the invention function;

FIG. 3 is block diagram of a network optimizer, in accordance with an embodiment of the invention; and

FIG. 4 is a flowchart illustrating the optimization of network connections, in accordance with an embodiment of the invention.

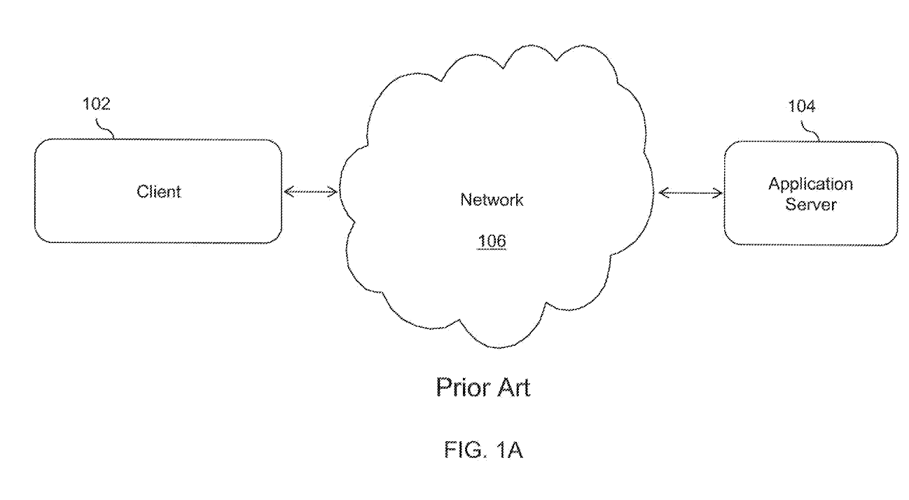

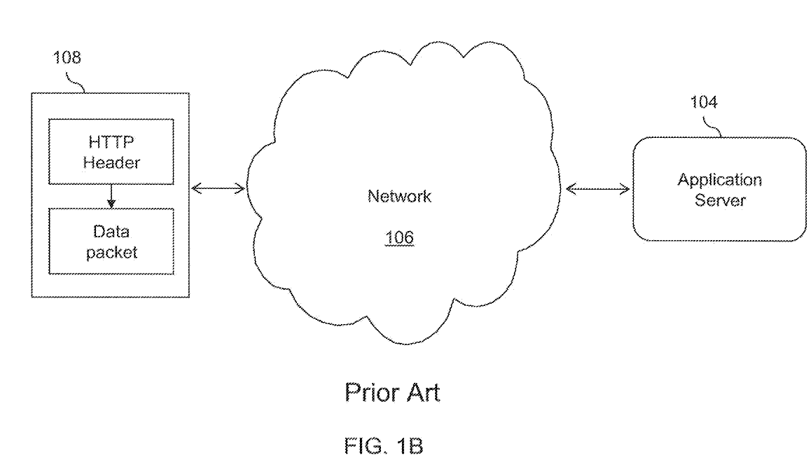

### DESCRIPTION OF EMBODIMENTS OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

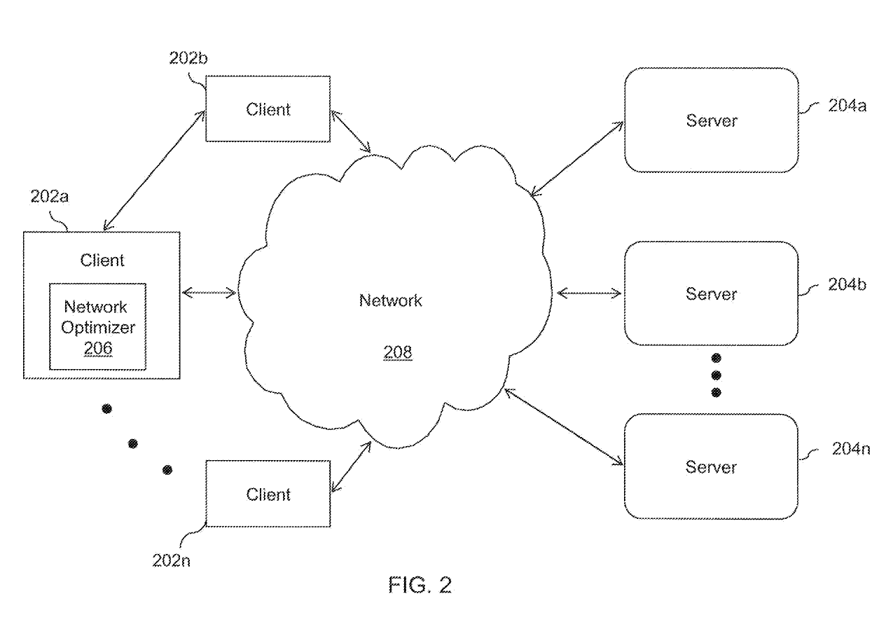

FIG. 2 illustrates an environment where various embodiments of the invention function. As shown, computing devices such as client 202a-n may communicate to interact and share information in a network 208 with devices such as a server 204a-n. Clients 202a-n can be, but are not limited to a mobile phone, a laptop, a personal computer, a smartphone and the like. Similarly, various other devices can be connected in network 208 through server 204a-n. Clients 202a-n can have different hardware and software platforms. Examples of software platforms include operating systems such as Windows, Linux, Macintosh, Symbian, and so forth. Moreover, clients 202a-n may have different hardware such as the screen size, screen resolution, audio and video functionality, processors and so forth.

Clients 202a-n may interact with each other through server 204a-n in real-time for activities such as chatting, playing games, banking and so forth. In an embodiment of the invention, clients 202a-n are connected in a peer-to-peer network. Clients 202a-n may interact from different types of network infrastructures. For example, client 202a may communicate with server 204a through a mobile network with a maximum bandwidth of 14.4 kbps and client 202b may communicate through an Ethernet network with a maximum bandwidth of 2 Mbps. Moreover, clients 202a-n can have different hardware and software capabilities. For example, client 202a may be a device such as a mobile phone and client 202b may be device such as a personal computer. Therefore, the communication between clients 202a-n is based on various network and device parameters. Examples of the parameters include, but are not limited to, a network port, network protocols, Internet protocol address of one or more servers and so forth.

In an embodiment of the invention, servers 204a-n are application servers. Servers 204a-n host applications services that are required by clients 202a-n. For example, the application can be an online game. In an embodiment of the invention, server 204a may be the main application server and servers 204b-n may be application servers available locally to clients 202a-n. An application can be executed on client 202a. Subsequently, client 202a connects to servers 204a-n for application services. In an embodiment of the invention, servers 204a-n function as source and clients 202a-n function as destination for application services. For example, in case of an online game, the application services can be the list of other players, game logic, and so forth. However, the user may experience latency in network connection due to various factors such as blocking or caching by an Internet Service Provider (ISP), low bandwidth and so forth. As a result, in case of an online game, there may be login delays, disconnections, and other game flow problems. Therefore, the network connection has to be optimized to maintain a stable and reliable connection between client 202a-n and servers 204a-n.

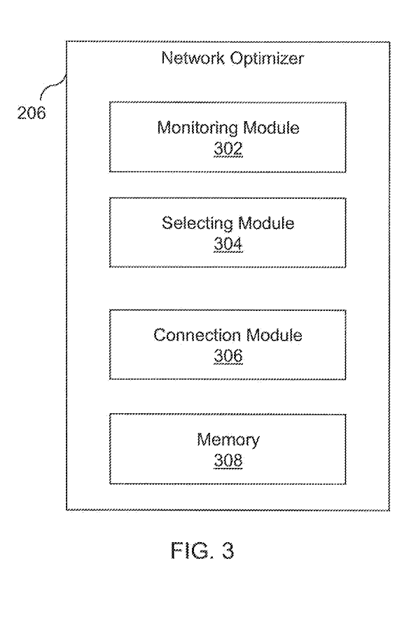

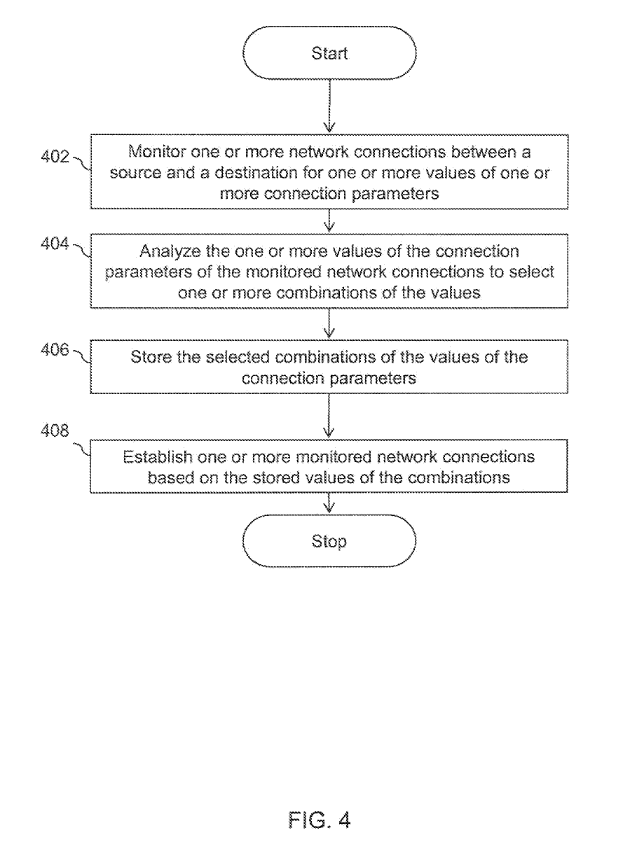

In an embodiment of the invention, client 202a comprises a network optimizer 206 for optimizing the network connections. Similarly, clients 202b-n can also include network optimizer 206. In an embodiment of the invention, network optimizer 206 monitors various network parameters and selects an optimum network connection based on values of connection parameters to establish the connections. The functioning of network optimizer 206 is explained in detail in conjunction with FIG. 3 and FIG. 4.

FIG. 3 is block diagram of network optimizer 206, in accordance with an embodiment of the invention. Network optimizer 206 selects, establishes and maintains optimum network connections between client 202 and servers 204a-n. In an embodiment of the invention, network optimizer 206 is a computing device for optimizing network connection. In another embodiment of the invention, network optimizer 206 can be implemented as hardware, software, firmware, or their combination on clients 202a-n. Network optimizer 206 comprises a monitoring module 302, a selection module 304, a connection module 306, and a memory 308.

Monitoring module 302 scans network connections between client 202a and servers 204a-n for values of various connection parameters. Connection parameters include, but are not limited to protocols, ports, server load, server IP address, and so forth. In an embodiment of the invention, monitoring module 302 uses a multithread technique for fast scanning of ports on client 202a. Monitoring module 302 comprises descriptions of various ports and port ranges. Moreover, monitoring module 302 determines values of the speed and bandwidth of network connections and Internet address of clients 202a-n and servers 204a-n. Furthermore, monitoring module 302 categorizes Internet Protocol (IP) addresses according to, but not limited to, different geographical locations, different physical servers, different network providers and so forth. In an embodiment of the invention, monitoring module 302 may capture data packets exchanged among client 202a and servers 204a-n. The captured data packets may then be analyzed, and the packet header information may be stored in a database. The packet header information may be analyzed to obtain connection parameters. In another embodiment of the invention, client 202a and servers 204a-n may exchange information regarding the connection parameters as a data packet while establishing a connection. The data packets can be exchanged and analyzed at the time of establishing a connection and/or after pre-defined intervals of time. In a further embodiment of the invention, monitoring module 302 may include a packet sniffer to scan and analyze the network connections for connection parameters and parameter values.

In an embodiment of the invention, monitoring module 302 monitors network connections by executing a separate thread, which runs in parallel with a main application on client 202a. In an embodiment of the invention, the values of connection parameters determined by monitoring module 302 are stored in memory 308. Examples of memory include, but are not limited to, Random Access Memory (RAM), a cache, a Dynamic RAM (DRAM), a Static RAM (SRAM), and so forth. In an embodiment of the invention, monitoring module 302 includes instructions that are executable by a processor for monitoring the network connections.

Selection module 304 analyzes the values of the connection parameters of monitored network connections. Moreover, selection module 304 select combinations of the values for optimum network connections. The values of connection parameters can be for examples port numbers, IP addresses of servers, protocols and so forth. Examples of combinations include, but are not limited to, the fastest port, IP address of a nearest server, and the supported protocol for a wireless phone. Furthermore, selection module 304 determines a suitable type of network for communication between client 202a and servers 204a-n. For example, in case of a mobile phone selection module 304 determines that Transmission Control Protocol (TCP) may be used and not Hyper Text Transfer Protocol (HTTP). Moreover, selection module 304 determines which connection should be selected. For example, if TCP is available then use it, else use HTTP, else use other protocol or a Short Messaging Service (SMS). Moreover, selection module 304 detects the type and capability of client 202. In an embodiment of the invention, selection module 304 selects a monitored network connection based on connection parameters such as the type, speed and bandwidth of a network connection. For example, client 202a-n may be on a fast computer connection, a slow computer connection, a fast wireless mobile, or a very limited bandwidth on a mobile phone. Therefore, the communications between clients 202a-n and servers 204a-n needs to balanced based on the utilization and cost. In an embodiment of the invention, selection module 304 uses a fast-wired connection to discover more and better combinations of network parameters. In another embodiment of the invention, selection module 304 conserves the available bandwidth on a wireless network connection. In yet another embodiment of the invention, selection module 304 conserves the air usage based on a user's paid mode and election in case client 202a is a mobile phone. For example, if the user pays for the amount of bandwidth consumed, then the bandwidth may be conserved.

The combination of values of the connection parameters in stored memory 308. The combination of values of the connection parameters can be stored in form of connection arrays. In an embodiment of the invention, the combination of values or the array is stored as databases memory 308. The connection array may include the server address, port, protocols and other details. Exemplary format of connection array can be:

Service-No.: {IP address, Port, Protocol}

Exemplary connection array available to client 202a can be:

Service-1: {198.162.1.1, 80, HTTP}

Service-2: {202.201.101.10, 40250, SSH}

In an embodiment of the invention, a user may login via HTTP to get the list of available services and the connection arrays.

Connection module 306 establishes a network connection between client 202a and server 204a based on the values of the connection parameters. In an embodiment of the invention, connection module 306 uses the information stored in memory 308 to establish network connections. Moreover, connection module 306 may check the last known connection parameters to select a new connection.

Connection module scans for various available protocols such as HTTP, TCP, UDP, HTTPS, SIP and so forth. Moreover, connection module 306 can use tunneling protocol to establish the network connection. Therefore, connection module 306 can use different protocols to encapsulate the network traffic or an unsupported protocol. For example, connection module 306 can encapsulate HTTP, FTP, SSH protocols with a protocol supported by mobile phone network such as TCP. Therefore, a suitable protocol for a network connection may be selected in real-time without delays. In an embodiment of the invention, connection module 306 implements peer-to-peer connections. Therefore, for establishing a connection between client 202a and servers 204a-n, a fast connection between client 202a and client 202b can be detected and the traffic can be redirected from client 202b to servers 204a-n. In an embodiment of the invention, connection module 306 can establish multiple simultaneous network connections. Moreover, the fastest connection of the multiple connections may be used first and duplicates may be dropped. Furthermore, connection module 306 can switch client 202a to another network connection in case a better combination of values is available. In another embodiment of the invention, connection module 306 categorizes and maintains network connections based on direction. Therefore, communications to servers 204a-n from clients 202a-n can use a first path and communications from servers 204a-n to clients 202a-n can use a second path. For example, the first path may be from server 2024a to client 202a directly through network 210 and the second path may be from client 202a to client 202b and then to server 204a. Therefore, an optimum network connection is maintained between client 202a and servers 204a-n. Moreover, the network connection is fast and reliable. Furthermore, multiple connections can be established and used based on the priority of the connections.

FIG. 4 is a flowchart illustrating the optimization of network connections, in accordance with an embodiment of the invention. At step 402, network connections between servers 204a-n and clients 202a-n are monitored for values of connection parameters. The network connections are monitored for values of connection parameters by monitoring module 302. Examples of connection parameters include, but are not limited to, network protocols, ports, servers load, server IP address, and so forth. Thereafter, at step 404, the values of the connection parameters of the monitored network connections are analyzed to select combinations of the values. Furthermore, protocols supported by the networks connections are determined. For example, in case of a mobile phone network it is determined that TCP protocol is supported but HTTP is not supported. Moreover, the status of connection may be determined, for example, an existing network connection between client 202a and servers 204a-n may be slow or blocked. The combination of the values and network connections are selected by selection module 304. Subsequently, at step 406 the selected combinations of the values of the connection parameters are stored in memory 308. In an embodiment of the invention, the combinations of the values are stored in memory 308 as an array of network connections. The connection array may include the server address, port, protocols and other details.

Thereafter, at step 408, one or more monitored network connections are established between client 202a and servers 204a-n based on the stored values of the combinations by connection module 306. Connection module 306 may use protocol tunneling to establish the monitored network connections. In this case, an unsupported protocol is encapsulated in a supported protocol to establish connection. As a result, an optimum network connection is maintained between client 202a-n and servers 204a-n. By way of an example in case of an online game, when client 202a experiences latency, a proposal for alternate connections with various game parameters such as game, room, and table may be provided. Subsequently, client 202a is connected to a local server 204b with a new connection and at the exact place of the ongoing game. As a result, a user at client 202a can move form a computer to the mobile device seamlessly. Therefore, the user can go out from one platform and get back from a new platform while maintaining the place in the game and the table of the online game without latency or break in connection.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general-purpose computers, special purpose computers, or other programmable data processing apparatus to produce machines, such that the instructions which execute on the computers or other programmable data processing apparatus create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. Furthermore, such computer program instructions may be made available for download and/or downloaded over a communication network.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method for optimizing network connections by a computing device, the method comprising:
monitoring one or more network connections between a source and a destination for one or more values of one or more connection parameters;
analyzing the one or more values of the connection parameters of the monitored network connections to select one or more combinations of the values;
storing the selected combinations of the values of the connection parameters; and
establishing one or more monitored network connections based on the stored values of the combinations.

2. The method of claim 1, wherein the connection parameters comprise one or more of: a network port, one or more network protocols, or Internet protocol address of one or more servers.

3. The method of claim 2, wherein the connection parameters further comprise one or more of: load on the servers or available bandwidth on the servers.

4. The method of claim 1, wherein the source comprises one or more application servers.

5. The method of claim 1, wherein the selected combinations of values comprise a fastest network port from one or more network ports.

6. The method of claim 1, wherein the selected combinations of values comprise a supported network protocol for the network connections.

7. The method of claim 1, wherein the selected combinations of values comprise an available Internet address.

8. The method of claim 7, wherein the available Internet address comprises an address of a nearest server from one or more servers.

9. The method of claim 1, wherein the selected combination of values comprise a maximum bandwidth of a server.

10. The method of claim 1, wherein the selected combination of values comprise a lowest load on a server.

11. The method of claim 1, wherein the network connections comprise peer-to-peer network connections.

12. The method of claim 1, wherein the network connections are established by utilizing protocol tunneling.

13. The method of claim 1, further comprising categorizing the network connections based on a direction of communication between the source and the destination.

14. The method of claim 13, wherein the direction of communication comprises communication from the source to the destination.

15. The method of claim 13, wherein the direction of communication comprises communication from the destination to the source.

16. The method of claim 1, wherein the one or more network connections comprise one or more of: a wired network or a wireless network.

17. The method of claim 1, wherein the destination comprises one or more mobile phones.

18. The method of claim 1, further comprising utilizing bandwidth of a wired connection from the one or more network connections to detect the one or more combinations.

19. The method of claim 1, further comprising utilizing bandwidth of a wireless connection from the one or more network connections based on a paid mode and election of a user.

20. The method of claim 1, wherein the combinations of the values of the connection parameters are stored as a connection array.

21. The method of claim 1, further comprising:
downloading executable instructions that, if executed by the computing device, cause the computing device to perform said monitoring, said analyzing, said storing, and said establishing.

22. The method of claim 1, further comprising:
providing for download executable instructions that, if executed by the computing device, cause the computing device to perform said monitoring, said analyzing, said storing, and said establishing.

23. A system for optimizing network connections, the system comprising:
means for monitoring one or more network connections between a source and a destination for one or more values of one or more connection parameters;
means for analyzing the one or more values of the connection parameters of the monitored network connections to select one or more combinations of the values;
means for storing the selected combinations of the values of the connection parameters; and
means for establishing one or more monitored network connections based on the stored values of the combinations.

24. The system of claim 23, wherein the one or more connection parameters comprise one or more of: a network port, one or more network protocols, or Internet protocol address of one or servers.

25. The system of claim 23, wherein the one or more connection parameters further comprise one or more of: load on the servers or available bandwidth on the servers.

26. The system of claim 23, wherein the selected combinations of values comprise one or more of: a fastest network port from one or more network ports, supported network protocol for the network connections, or an available Internet address.

27. The system of claim 23, wherein the network connections comprise one or more peer-to-peer network connections.

28. The system of claim 23, wherein the network connections are established by utilizing protocol tunneling.

29. The system of claim 23, further comprising means for categorizing the network connections based on a direction of communication.

30. The system of claim 23, wherein the destination comprises one or more mobile phones.

31. The system of claim 23, further comprising means for utilizing bandwidth of a wired connection from the network connections to detect the one or more combinations.

32. The system of claim 23, further comprising means for utilizing bandwidth of a wireless connection from the network connections based on a paid mode and election of a user.

33. An apparatus for optimizing network connections, the apparatus comprising:
a monitoring module configured to monitor one or more network connections between a source and a destination for one or more values of one or more connection parameters;
a selection module configured to analyze the one or more values of the connection parameters of the monitored network connections to select one or more combinations of the values;
a memory configured to store the selected combinations of the values of the connection parameters; and
a connection module configured to establish one or more monitored network connections based on the stored values of the combinations.

34. The apparatus of claim 33, wherein the one or more connection parameters comprise one or more of: a network port, one or more network protocols, or Internet protocol address of one or servers.

35. The apparatus of claim 33, wherein the selected combinations of values comprise one or more of: a fastest network port from one or more network ports, supported network protocol for the network connections, or an available Internet address.

36. The apparatus of claim 33, wherein the connection module is configured to establish the network connections by utilizing protocol tunneling.

37. The apparatus of claim 33, wherein the selector module is further configured to utilize bandwidth of a wired connection from the network connections to detect the one or more combinations.

38. The apparatus of claim 33, the selector module is further configured to utilize bandwidth of a wireless connection from the network connections based on a paid mode and election of a user.

39. The apparatus of claim 33, wherein the combinations of the values of the connection parameters are stored as a connection array.

40. A computer-readable medium having stored thereon instructions that, if executed by a computing device, cause the computing device to execute a method comprising:
monitoring one or more network connections between a source and a destination for one or more values of one or more connection parameters;
analyzing the one or more values of the connection parameters of the monitored network connections to select one or more combinations of the values;
storing the selected combinations of the values of the connection parameters; and
establishing one or more monitored network connections based on the stored values of the combinations.

41. The computer-readable medium of claim 40, wherein the one or more connection parameters comprise one or more of: a network port, one or more network protocols, or Internet protocol address of one or servers.

42. The computer-readable medium of claim 40, wherein the selected combinations of values comprise one or more of: a fastest network port from one or more network ports, supported network protocol for the network connections, or an available Internet address.
